(19) United States
(12) Patent Application Publication
(10) Pub. No.: US 2016/0216001 A1
(43) Pub. Date: Jul. 28, 2016

(54) SINGLE PIECE REGISTER COVER

(71) Applicant: Kenneth Alan Szarek, Beaufort, SC (US)

(72) Inventor: Kenneth Alan Szarek, Beaufort, SC (US)

(21) Appl. No.: 14/603,494

(22) Filed: Jan. 23, 2015

(51) Int. Cl. F24F 13/28; B01D 46/00; B23P 6/00

(52) U.S. Cl. CPC F24F 13/28; B23P 6/00; B01D 46/0005; B01D 46/001

(57) ABSTRACT

A single piece register cover adapted to attach to an existing air register. The single piece register cover has a frame having a front surface and a rear surface, two sidewalls, upper and lower sidewalls and a central section between first and second sidewalls and upper and lower sidewalls formed in the frame that it fits over openings in the existing air register. The central section generally sized to correspond to a central opening through the air register. A plurality of immovable louvers having openings therebetween are formed in the central section and extend between the first and second sidewalls. An air filter is disposed between the plurality of immovable louvers formed in the central section and the central opening through the air register to filter air that enters through the openings in the air register.

This non-provisional application claims the benefit of the provisional application filed with the United States Patent and Trademark Office as Application No. 61/929,567 entitled SINGLE PIECE REGISTER COVER, filed Jan. 23, 2014.

### TECHNICAL FIELD OF THE INVENTION

The present invention relates to an air register cover and more particularly to a single piece register cover adapted to attach to an existing air register.

### BACKGROUND OF THE INVENTION

Most houses and businesses are equipped with heating, ventilating and air-conditioning systems. These systems treat air by heating it or cooling it. Air forced through heating, ventilation and air-conditioning (HVAC) systems is generally output through ducts to one or more registers (also referred to as a vents or diffusers), which are located in predetermined locations throughout a building. HVAC systems generally have a series of ducts contained within the building's walls, ceilings and attic crawl spaces. The ducts carry forced air (e.g., heated air or cooled air) to the registers located in the living and/or work areas. The ducts are attached to the back side of an interior surface (e.g. sheetrock, ceiling, wallboard, a finished or un-finished surface, etc.) at openings designed for the register. A register fits into the opening in the interior surface, i.e., the wallboard, and is attached by several sheet metal screws. The system treated air is pressurized and forced through the register. The airstream exiting from the register or air register has a much higher velocity compared to the air within the room wherein the register is positioned. The air that exits the register is intended to fill the interior living or work space within the room in order to maintain a desired temperature level.

The use of air filters to remove particulate matter from an HVAC system's airflow is well known. Modern air filters are generally comprised of a filtering media and a support structure to carry the filtering media. Typically, the filtering media is comprised of a substantially flexible fibrous material, either of natural and/or synthetic origin, that is capable of retaining particulate matter contained in an airflow passing through the filtering media.

### SUMMARY OF THE INVENTION

According to an embodiment of the present invention, there is disclosed a single piece register cover adapted to attach to an existing air register. The single piece register cover has a frame having a front surface and a rear surface, two sidewalls, upper and lower sidewalls and a central section between first and second sidewalls and upper and lower sidewalls formed in the frame that it fits over openings in the existing air register. The central section generally sized to correspond to a central opening through the air register. A plurality of immovable louvers having openings therebetween are formed in the central section and extend between the first and second sidewalls. An air filter is disposed between the plurality of immovable louvers formed in the central section and the central opening through the air register to filter air that enters through the openings in the air register.

According to another embodiment of the present invention, the method of attaching a single piece register cover to an existing air register comprises providing a single piece register cover having a frame having a front surface and a rear surface, two sidewalls, upper and lower sidewalls, and a central section between the first and second sidewalls and the upper and lower sidewalls. Then, sizing the central section to correspond to a central opening through the air register so that the frame fits over openings in the existing air register and providing a plurality of immovable louvers having openings therebetween in the central section. Finally, disposing an air filter between the plurality of immovable louvers formed in the central section and the central opening through the air register to filter air that enters through the openings in the air register.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a front, three-dimensional schematic view of the single piece register cover and an air register, in accordance with the present invention.

FIG. 2 is a rear, three-dimensional view of the single piece register cover and an air filter, in accordance with the present invention.

FIG. 3 is a rear, three-dimensional schematic view of the single piece register cover and an air filter, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

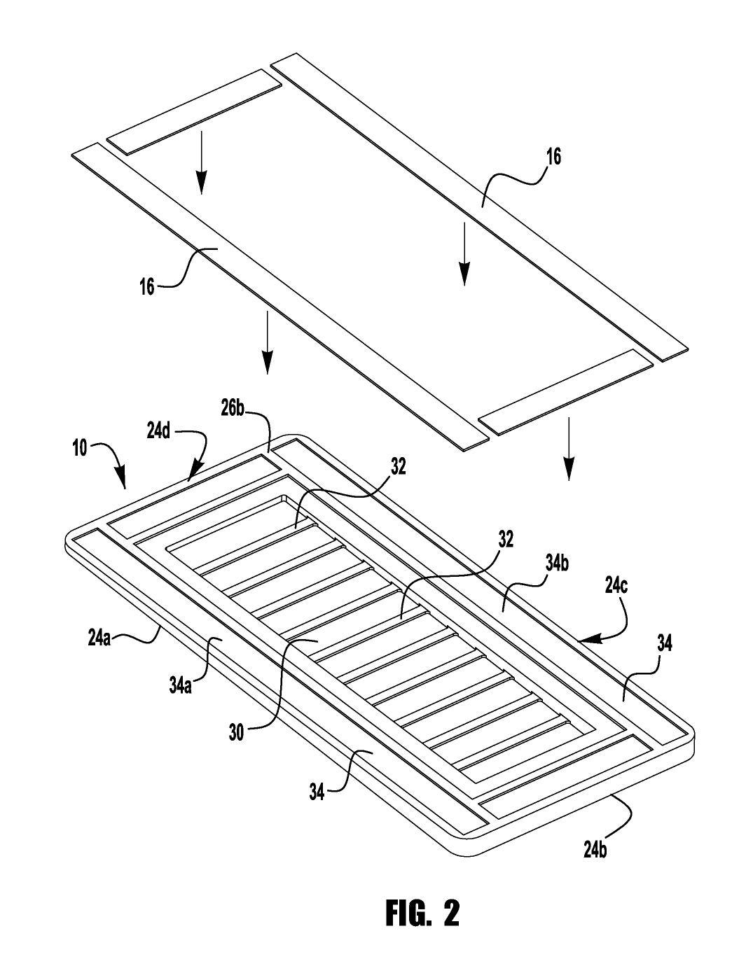

Studies have shown that indoor air may be two to five times more polluted than outdoor air. This conclusion raises obvious health concerns, and suggests that appropriate steps should be taken to address this issue. The primary defense mechanism for building occupants is effective filtration utilized in conjunction with the structure's heating, ventilation and air-conditioning (HVAC) system. The filtration is generally utilized at the inlet to the HVAC system. However, dust, mold or other particulate matter may be present or accumulate in the ducting system, past the inlet filter. The single piece, register cover 10 magnetically attaches to any existing metal air register 12 that is installed in a building. In general terms, the single piece, register cover 10 is designed to attach to the metal air register 12 via magnets 16, see FIG. 2, and hold an air filter 38 between immovable louvers 32 of the register cover 10 and the slats 19 between the openings 20 of the installed air register 12. The register cover 10 simplifies manufacturing by being constructed of a single, preformed, configuration of a plastic polymer having a plurality of magnets 16 rather than a more complicated design of multiple plastic pieces.

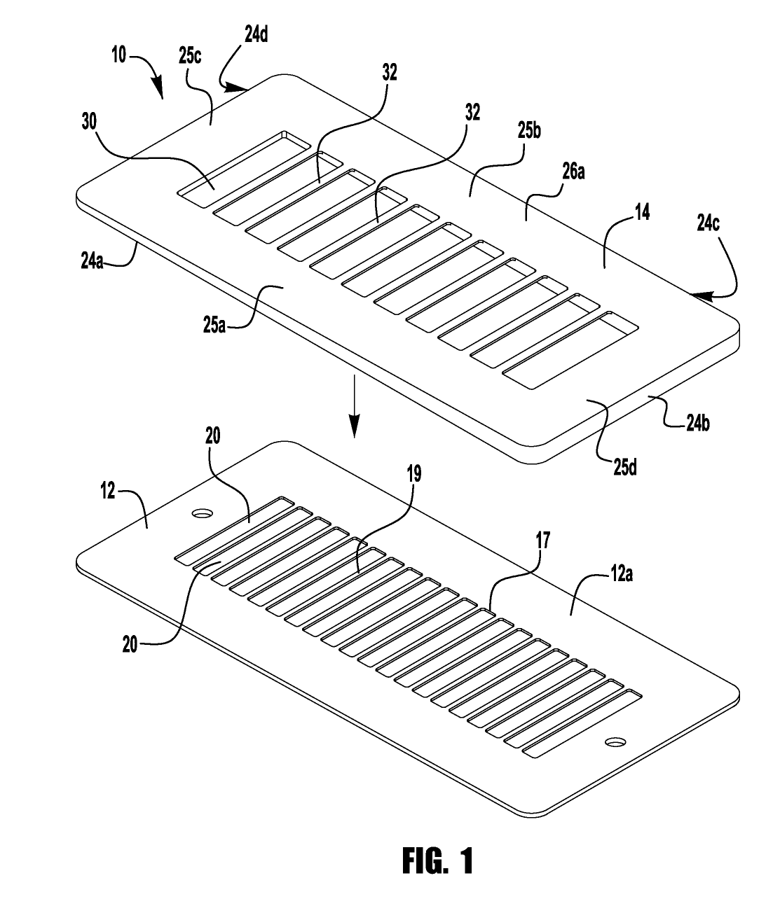

FIG. 1 illustrates a front, three-dimensional schematic view of the single piece register cover 10 in relation to a metal air register 12. The register cover 10 is a generally rectangular frame designed to be removably attached to the air register 12. The register cover 10 is typically mounted within a wall, floor, or ceiling, with the exterior facing surface 12a facing outwardly, into a room. Air register 12 conventionally has a central opening 17 having a plurality of slats 19 with openings 20 therebetween along the length of the central opening 17. The openings 20 between slats 19 formed in the register cover 10 allow forced air from the ducting system to flow therethrough.

The register cover 10 is designed to filter the flow of air through the register cover 12. It is further within terms of the embodiment that the register cover 10 be configured to attach to walls, ceilings, frames, etc. which are not the air register 12 itself. Although the register cover 10 is shown as being substantially rectangular in configuration, it will be appreciated by the skilled artisan that any number of suitable configurations are possible, including squares, ovals, circles, and the like. The register cover 10 may be any suitable dimensions. Further, register cover 10 may be used in connection with all types of air register covers 12 (e.g., wall registers, louvered registers, patterned registers, etc.). As illustrated in its rectangular embodiment in FIG. 1, exemplary dimensions may include a width of between 1.5 and 3 inches, and a length between 3 and 5 inches. However, the register cover 10 can be of any desired dimensions.

The register cover 10 is comprised of a frame 14, formed of a single piece, that secures an air filter 16. Typically, the frame 14 can be formed from plastic by injection molding. The plastic from which the frame 14 is fabricated must be durable so that it can undergo hot and cold temperature changes from the air flowing through the air register 12. As illustrated, the edges 24a 24b, 24c, and 24d (24a-24d) of the frame 14 are flat surfaces, but it is within the terms of the embodiment that the edges be beveled. The purpose of the edges 24a-24d being beveled is to not restrict air flow into and from the air register 12. The edges 24a-24d may have an exemplary height of 10 mm. In either configuration, the frame 14 is designed so that it does not interfere with the operation of the air register 12.

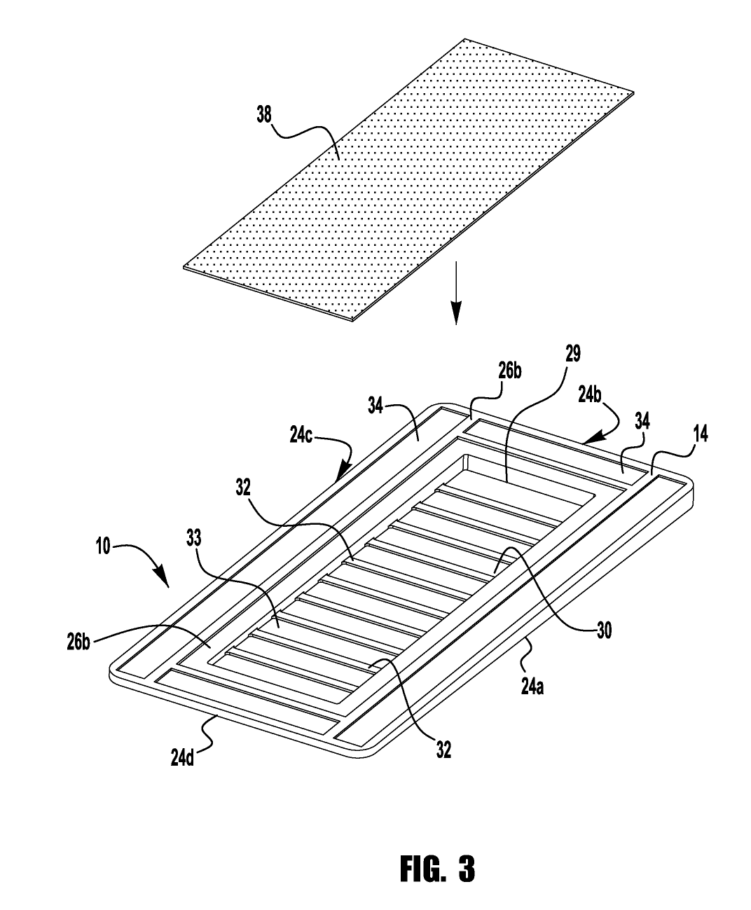

As illustrated in FIG. 1, the frame 14 is formed with a front surface 26a and a rear surface 26b, which is illustrated in FIG. 2. Frame 14 has first and second sidewalls 25a and 25b and upper and lower sidewalls 25c and 25d. A central section 30 is formed in the frame 14 between the first and second sidewalls 25a and 25b and the upper and lower sidewalls 25c and 25d. The size of the central section 30 generally corresponds to the central opening 17 of the air register 12. A plurality of thin immovable louvers 32 are formed in the central section 30 and extend between the sidewalls 25a and 25b. Between the thin immovable louvers 32 are openings 33 to allow air to flow through frame 14 after the register cover 10 has been placed over the air register 12. The immovable louvers 32 are recessed such that they do not extend to the rear surface 26b of the frame 14. The recess forms a cavity 29 between the immovable louvers 32 and the rear surface 26b of the frame 14, as seen in FIG. 3.

FIG. 2 illustrates the rear surface 26b of the frame 14. The rear surface 26b interfaces with the exterior frame 12a of the air register 12, such that it is removably attached thereto. The rear surface 26b may be attached to the air register 12 in any desired fashion, such as with an adhesive or a pair of fasteners, such as screws, or, in the alternative, as illustrated, the register cover 10 may be secured to the air register 12 magnetically. One or more recessed grooves 34, preferably two or four grooves, are formed or disposed within the rear surface 26b. For example, recessed grooves 34a and 34b extend substantially the length of the register cover 10. Another set of recessed grooves 34c and 34d at either end of cover 10 extend between 34a and 34b. These grooves 34 are designed to accommodate strips of magnetic tape 16, which allow the register cover 10 to be quickly and easily attached to and removed from the air register 12. The strips of magnetic tape 16 can have an adhesive on one side to attach them within the grooves 34.

When the register cover 10 is placed over a register 12, the magnetic tape 16 disposed within the grooves on the rear surface 26b comes in contact with the exterior frame 12a of the air register and thereby secures the cover 10 to the air register 12. The grooves 34 are recessed to a depth such that an outward facing surface of the magnetic tape 16 secured therein will be below or flush with the rear surface 26b of the register cover 10 to ensure the flush mating of the cover 10 to the air register 12. Thus, the register cover 10 forms a tight seal over the air register 12 between the register cover and the exterior frame 12a of the register.

FIG. 3 illustrates the rear surface 26b of the frame 14 and an air filter 38. In general, the air filter 38 is air permeable and may be constructed of any material and have any configuration that catches particles yet allows air to pass through. The air filter 38 may include a screen or mesh formed of any suitable material, or, it may be formed of a breathable fabric that is air permeable or has pores allowing air to pass. The air filter can be comprised of fibrous materials that act to remove solid particles such as dust, pollen, mold, and bacteria from the air entering the room through the air register 12. The air filter 38 rests in the cavity 29 and is held in place between the immovable louvers 32 and the slats 19 in the air register 12 whereby the rear surface of the rear surface 26b of the frame 14 is flush with the air register 12.

It is further within the terms of the embodiment that the air filter 38 be attached to the cavity formed between the immovable louvers 32 and the rear surface 26b with an adhesive, although this is not necessary. The adhesive may be applied to the air filter 38 by any number of conventional methods, including spraying, streaming, brushing, rubbing, rolling, and the like. The exact choice of adhesive is not thought to be critical, provided that the adhesive employed is capable of adhering to the filtering media and an air supply and/or an air return register under various temperature, humidity, and air pressure conditions. The adhesive should preferably be easy to clean and should not harm the registers or any surrounding surfaces.

In use, the register cover 10 is removably attached to the air register 10. The magnets 16 on the rear surface 26b of the frame 26 attach to the exterior frame 12a of the air register 12. The immovable louvers 32 of the register cover 10 are placed directly above the openings 20 of the air register 12, through which air enters the room. An air filter 38 is held in place between the immovable louvers 32 and the openings 20, thereby filtering the air that enters through the openings. In the event that the air filter 38 needs to be changed, the register cover 10 may quickly be removed and then returned to position on the air register 12 after the filter has been changed.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A single piece register cover adapted to attach to an existing air register, comprising:
a frame having a front surface and a rear surface, two sidewalls, upper and lower sidewalls;
a central section between first and second sidewalls and upper and lower sidewalls formed in the frame that it fits over openings in the existing air register, the central section generally sized to correspond to a central opening through the air register;
a plurality of immovable louvers formed in the central section and extending between the first and second sidewalls, the plurality of immovable louvers having openings therebetween; and
an air filter disposed between the plurality of immovable louvers formed in the central section and the central opening through the air register to filter air that enters through the openings in the air register.

2. The single piece register cover of claim 1, wherein the single piece register cover is adhesively attached to the existing air register.

3. The single piece register cover of claim 1, wherein the existing air register is formed of metal and the single piece register cover is magnetically attached thereto.

4. The single piece register cover of claim 1, wherein:
at least one recessed groove is disposed within the rear surface of the frame; and
a strip of magnetic tape is disposed within the recessed groove.

5. The single piece register cover of claim 4, wherein at least two recessed grooves are formed within the rear surface of the frame; and
a strip of magnetic tape is disposed within each of the recessed grooves.

6. The single piece register cover of claim 5, wherein the strip of magnetic tape is adhesively attached within each of the recessed grooves.

7. The single piece register cover of claim 6, wherein the depth of the recessed grooves are such that an outward facing surface of the magnetic tape secured therein will be below or flush with the rear surface of the register cover to ensure the flush mating of the register cover to the air register.

8. The single piece register cover of claim 1, wherein the immovable louvers are recessed such that they do not extend to the rear surface of the frame.

9. The single piece register cover of claim 8, wherein a cavity is formed between the immovable louvers and the rear surface of the frame.

10. The single piece register cover of claim 9, wherein the air filter rests in the cavity formed between the immovable louvers and the rear surface of the frame and is held in place between the immovable louvers and the air register to ensure the flush mating of the register cover to the air register.

11. The single piece register cover of claim 10, wherein the air filter is attached to the cavity formed between the immovable louvers and the rear surface of the frame with an adhesive.

12. The single piece register cover of claim 1, wherein the frame is constructed of a single, preformed, configuration of a plastic polymer.

13. The single piece register cover of claim 1, wherein the air filter can be comprised of fibrous materials that act to remove solid particles such as dust, pollen, mold, and bacteria from the air passing through the filter.

14. The method of attaching a single piece register cover to an existing air register, comprising:
providing a single piece register cover having a frame having a front surface and a rear surface, two sidewalls, upper and lower sidewalls, and a central section between the first and second sidewalls and the upper and lower sidewalls;
sizing the central section to correspond to a central opening through the air register so that the frame fits over openings in the existing air register;
providing a plurality of immovable louvers having openings therebetween in the central section and extending between the first and second sidewalls; and
disposing an air filter between the plurality of immovable louvers formed in the central section and the central opening through the air register to filter air that enters through the openings in the air register.

15. The method of claim 14 including:
providing the existing air register of metal; and
magnetically attaching the single piece register cover to the existing air register.

16. The method of claim 15 including:
providing the register cover having at least two recessed grooves within the rear surface of the frame; and
disposing a strip of magnetic tape within each of the recessed grooves.

17. The method of claim 16 including securing the magnetic tape within the recessed grooves so that the magnetic tape is below or flush with the rear surface of the register cover.

18. The method of claim 16 including recessing the immovable louvers such that they do not extend to the rear surface of the frame and a cavity is formed between the immovable louvers and the rear surface of the frame.

19. The method of claim 18 including resting the air filter in the cavity formed between the immovable louvers and the rear surface of the frame whereby the air filter is held in place between the immovable louvers and the air register to ensure the flush mating of the register cover to the air register.

20. The single piece register cover of claim 19 including attaching the air filter in the cavity formed between the immovable louvers and the rear surface of the frame with an adhesive.
